(19) United States
(12) Patent Application Publication
(10) Pub. No.: US 2019/0000079 A1
(43) Pub. Date: Jan. 3, 2019

(54) Methods and Formulation for Treatment of Nuts, Seeds, Grains, Cereals, Plant Growth Media, and Plants

(71) Applicant: Lipotec Laboratories, LLC, Champaign, IL (US)

(72) Inventor: Kenneth L. Watkin, Champaign, IL (US)

(21) Appl. No.: 15/545,005

(22) PCT Filed: Jan. 20, 2016
(86) PCT No.: PCT/US2016/014088

§ 371 Date: Jul. 20, 2017

Related U.S. Application Data
(60) Provisional application No. 62/105,403, filed on Jan. 20, 2015.
(60) Provisional application No. 62/274,310, filed on Jan. 3, 2016.

(51) Int. Cl. A01N 35/02; A01N 65/48; A01N 25/02; A01N 43/78; A01N 43/36

(52) U.S. Cl. CPC A01N 35/02; A01N 65/48; A01N 43/36; A01N 43/78; A01N 25/02

(57) ABSTRACT

The invention provides methods and compositions for the control and treatment of pests, insects, fungi, and nematodes in seeds, nuts, cereals, grains, plant growth media, plants, plant parts, and reproductive plant parts. One embodiment of the invention provides a composition comprising a seed, nut, cereal, or grain coated with a formulation. The formulation can comprise: (1) curcumin and a polar aprotic solvent; or (2) finely ground curcumin and a polar protic solvent. The formulation can further comprise carboxymethyl cellulose, one or more polymers or combinations thereof. The polar aprotic solvent can be dimethyl sulfoxide (DMSO) and the polar protic solvent can be water.

### PRIORITY

This application claims the benefit of U.S. provisional application Ser. No. 62/105,403, filed on Jan. 20, 2015, and U.S. provisional application Ser. No. 62/274,310, filed on Jan. 3, 2016, both of which are incorporated herein in their entirety.

### BACKGROUND OF THE INVENTION

Curcumin (diferuloylmethane) is the active yellow pigment in turmeric, a plant-derived coloring spice and ingredient in many cosmetics and pharmaceuticals. Curcumin has been associated with many biological and cellular activities including antioxidative, anti-inflammatory, anticarcinogenic and hypocholesterolemic properties. The role of curcumin has been extensively explored for human medicinal purposes. Little attention has been focused on the use of curcumin for the treatment of plant diseases and plant protection from pests. Curcumin, however is not generally soluble in water making its utilization difficult.

### BRIEF DESCRIPTION OF THE DRAWING

FIG. 1 shows a microscopic image (20×) of the curcumin particles in a curcumin composition of the invention.

### SUMMARY OF THE INVENTION

One embodiment of the invention provides a composition comprising a seed, nut, cereal, or grain coated with a formulation. The formulation can comprise: (1) curcumin and a polar aprotic solvent; or (2) finely ground curcumin and a polar protic solvent. The formulation can further comprise carboxymethyl cellulose, one or more polymers or combinations thereof. The polar aprotic solvent can be dimethyl sulfoxide (DMSO) and the polar protic solvent can be water.

One embodiment of the invention provides a composition comprising a seed, nut, cereal, or grain coated with a formulation comprising carboxymethyl cellulose, dimethyl sulfoxide, and curcumin. The seed, nut, grain, or cereal can further be coated with one or more fungicides, one or more nematicides, one or more pesticides, one or more polymers, or combinations thereof.

Another embodiment of the invention provides a composition comprising a seed, nut, cereal, or grain coated with (a) liposomes having curcumin loaded in the core of the liposomes and one or more pesticides, nematicides, or fungicides; (b) liposomes having curcumin loaded in the core of the liposomes and liposomes having one or more pesticides, nematicides, or fungicides loaded in the core of the liposomes; or (c) liposomes comprising a combination of curcumin and one or more pesticides, nematicides, or fungicides. The curcumin can be present in the formulations at about 0.1 mg/L⁻¹ to about 400 mg/L⁻¹. The seed, nut, cereal, or grain can also be coated with one or more polymers.

Another embodiment of the invention provides a method of coating a cereal, seed, nut, or grain. The method comprises: (a) combining curcumin with a polar aprotic solvent to form a curcumin solution; or (b) combining finely ground curcumin with a polar protic solvent to form a curcumin solution. The curcumin solution is then used to coat the cereal, seed, nut, or grain. The cereal, seed, nut or grain can further be coated with one or more fungicides, one or more nematicides, one or more pesticides, one or more polymers, or combinations thereof.

Even another embodiment of the invention provides a method of coating a cereal, seed, nut, or grain. The method comprises:
(a) combining carboxymethyl cellulose with an aqueous solution to form an aqueous carboxymethyl cellulose solution;
(b) combining the aqueous carboxymethyl cellulose solution with curcumin and dimethyl sulfoxide to form a carboxymethyl cellulose, curcumin and dimethyl sulfoxide solution; and
(c) coating the cereal, seed, nut, or grain with the carboxymethyl cellulose, curcumin and dimethyl sulfoxide solution.
   The cereal, seed, nut or grain can further be coated with one or more fungicides, one or more nematicides, one or more pesticides, one or more polymers, or combinations thereof. The one or more fungicides, one or more nematicides, one or more pesticides, or combinations thereof can be encapsulated in one or more liposomes. The curcumin can be encapsulated in liposomes (with or without the one or more fungicides, one or more nematicides, one or more pesticides, or combinations thereof).

Still another embodiment of the invention provides a method of coating a cereal, seed, nut, or grain. The method comprises:
(a) coating the cereal, seed, nut, or grain with an aqueous carboxymethyl cellulose solution to form a carboxymethyl cellulose coated cereal, seed, nut or grain; and
(b) coating the carboxymethyl cellulose coated cereal, seed, nut, or grain with a curcumin and dimethyl sulfoxide solution.
   The cereal, seed, nut or grain can further be coated with one or more fungicides, one or more nematicides, one or more pesticides, one or more polymers, or combinations thereof. The one or more fungicides, one or more nematicides, one or more pesticides, or combinations thereof can be encapsulated in one or more liposomes. The curcumin can be encapsulated in liposomes (with or without the one or more fungicides, one or more nematicides, one or more pesticides, or combinations thereof).

Yet another embodiment of the invention provides a method of controlling fungi, insects, nematodes, or combinations thereof in cereals, grains, seeds or nuts. The method comprises coating the cereals, grains, seeds and nuts with a formulation comprising curcumin and a polar aprotic solvent or finely ground curcumin and a polar protic solvent, and optionally, one or more fungicides, one or more nematicides, one or more pesticides, one or more polymers, or combinations thereof. The one or more fungicides, one or more nematicides, one or more pesticides, or combinations thereof can be encapsulated in one or more liposomes. The curcumin can be encapsulated in liposomes (with or without the one or more fungicides, one or more nematicides, one or more pesticides, or combinations thereof).

Another embodiment of the invention provides a method of cultivating a seed. The method comprises coating the seed with a formulation comprising curcumin and a polar aprotic solvent or finely ground curcumin and a polar protic solvent, and optionally, one or more fungicides, one or more nematicides, one or more pesticides, one or more polymers, or combinations thereof; contacting the seed with a medium suitable for germination; and adding water. The one or more fungicides, one or more nematicides, one or more pesticides, or combinations thereof can be encapsulated in one or more liposomes. The curcumin can be encapsulated in liposomes (with or without the one or more fungicides, one or more nematicides, one or more pesticides, or combinations thereof).

Still another embodiment of the invention provides a method of treating a plant growth medium. A plant growth medium can be soil, soil-less medium (e.g., sphagnum peat moss, perlite, vermiculite, lime, fertilizer, or combinations thereof), sand, bark fines, wood mulch, compost, liquid medium or combinations thereof. The method comprises contacting the plant growth medium with a formulation comprising curcumin and a polar aprotic solvent or finely ground curcumin and a polar protic solvent, and optionally, one or more fungicides, one or more nematicides, one or more pesticides, or combinations thereof. The one or more fungicides, one or more nematicides, one or more pesticides, or combinations thereof can be encapsulated in one or more liposomes. The curcumin can be encapsulated in liposomes (with or without the one or more fungicides, one or more nematicides, one or more pesticides, or combinations thereof).

Even another embodiment of the invention provides a method for treating an infection or potential infection of a plant, part of a plant, reproductive plant material, or seed by fungi, insects or nematodes. The method comprises contacting the plant, part of a plant, reproductive plant material, or seed with a formulation comprising curcumin and a polar aprotic solvent or finely ground curcumin and a polar protic solvent, and optionally, one or more fungicides, one or more nematicides, one or more pesticides, one or more polymers, or combinations thereof. The one or more fungicides, one or more nematicides, one or more pesticides, or combinations thereof can be encapsulated in one or more liposomes. The curcumin can be encapsulated in liposomes (with or without the one or more fungicides, one or more nematicides, one or more pesticides, or combinations thereof).

For each of the methods above the formulation can further comprise carboxymethyl cellulose and the polar aprotic solvent can be dimethyl sulfoxide (DMSO) and the polar protic solvent can be water.

### DETAILED DESCRIPTION OF THE INVENTION

As used herein, the singular forms “a,” “an”, and “the” include plural referents unless the context clearly dictates otherwise. The term “about” in association with a numerical value means that the numerical value can vary plus or minus by 5% or less of the numerical value.

### Compositions

Compositions of the invention include formulations for antifungal, nematicidal, and pesticidal seed, nut, grain and cereal coatings; formulations for the control of fungi, pests, nematodes, and insects in seeds, nuts, grains and cereals; formulations for treatment of plants and plant parts; and formulations for growth medium treatment for the control of insects, fungi, pests, and nematodes.

A composition can comprise any type of seed, nut, cereal, grain or combination thereof, including for example, beans, legumes, cereals, pseudocereals, and nut-like gymnosperm seeds. Seeds, nuts, cereal and grain can be edible or can be used for plant propagation. A seed can be in a dormant state (exogenous; endogenous; combinational; and secondary dormant states or morphological, physiological, morphophysiological, physical and combinational dormancy states).

The seeds, nuts, cereal or grains can be coated with a formulation comprising curcumin and one or more solvents. A solvent of the invention can be a polar solvent, non-polar solvent (having a dielectric constant less than 5), a polar protic solvent (a solvent having O—H or N—H bonds, which can serve as a source of protons (H+)), or polar aprotic solvent (a solvent lacking O—H or N—H bonds). Examples of non-polar solvents include pentane, hexane, cyclohexane, benzene, toluene, chloroform, and diethyl ether.

Polar aprotic solvents have large dielectric constants (20 or greater) and large dipole moments, but they do not participate in hydrogen bonding (no O—H or N—H bonds). Examples of polar aprotic solvents include acetone, N,N-dimethylforrnamide (DMF), acetonitrile, dimethyl sulfoxide (DMSO). Borderline polar aprotic solvents have moderately higher dielectric constants than nonpolar solvents (between about 5 and 20). Examples of borderline polar aprotic solvents include dichloromethane, tetrahydrofuran (THF), and ethyl acetate.

Polar protic solvents have high dielectric constants (greater than 5) and high dipole moments. They possess O—H or N—H bonds and can participate in hydrogen bonding. These solvents can also serve as acids (sources of protons) and weak nucleophiles (forming bonds with strong electrophiles). Examples of polar protic solvents include ammonia, t-butanol, n-propanol, ethanol, methanol, acetic acid, and water.

In one embodiment of the invention the formulation comprises a non-polar solvent such as hexane and curcumin. In another embodiment of the invention, the formulation comprises a polar aprotic solvent such as DMSO and curcumin. In one embodiment of the invention, the formulation comprises a polar protic solvent such as water and finely ground curcumin. Finely ground curcumin is ground to a particle size of about 50 to about 5,000 nm, for example about 50, 100, 200, 300, 400, 500, 600, 700, 800, 900, 1,000, 2,000, 3,000, 4,000, 5,000 or more nm; or about 5,000, 4,000, 3,000, 2,000, 1,000, 900, 800, 700, 600, 500, 400, 300, 200, 100, 50 or less nm; or any range between about 50 and about 5,000 nm (e.g., between about 50 and 200, 200 and 800, 800 and 5,000, 400 and 4,000). Any formulation of the invention can optionally comprise carboxymethyl cellulose.

In one embodiment of the invention the seeds, nuts, cereal, grains, plants, plant parts, or plant growth media are coated or contacted with a formulation comprising carboxymethyl cellulose, a polar aprotic solvent such as dimethyl sulfoxide, and curcumin.

The curcumin can be present in a formulation at about 0.01, 0.1, 0.5, 1, 5, 10, 20, 30, 40, 50, 60, 70, 80, 90, 100, 125, 150, 175, 200, 300, 400 or more mg/L⁻¹ (or at any range between about 0.1 and about 200 mg/L⁻¹. Alternatively, the curcumin can be present at about 400, 300, 200, 175, 150, 125, 100, 90, 80, 70, 60, 50, 40, 30, 20, 10, 5, 1, 0.5, 0.1, 0.01, or less mg/L⁻¹ (or any range between about 400 and about 0.01 mg/L⁻¹). In one embodiment, when used as an insecticide, curcumin can be present at about 1 to about 100 mg/L⁻¹. In one embodiment, when applied to plant growth medium, curcumin can be present at about 1.0 to about 200 mg/L⁻¹ (e.g., about 1, 20, 50, 100 or 200 mg/L⁻¹). Carboxymethyl cellulose can be present in the formulation at about 0.01 to about 0.4 mg. The solvent can be present in the formulation at about 1 to about 5 mL.

Carboxymethyl cellulose can be used in the MW range of about 90, 100, 200, 300, 400, 500, 600, 700 kDa or more (or any range between about 90 and 700 kDa). The carboxymethyl cellulose can be used in the MW range of about 700, 600, 500, 400, 300, 200, 100, 90 kDa or less (or any range between about 700 and 90 kDa).

Cereals, nuts, grains and seeds can be coated with compositions or formulations of the invention. Coated means that the compositions or formulations of the invention cover about 30, 40, 50, 60, 70, 80, 90, or 100% (or any range between about 30 and about 100%) of the surface of the cereals, nuts, grains and seeds. The coating is substantially immobilized to the surface of the cereals, nuts, grains and seeds when dried. The coating can be released from the surface of the cereals, nuts, grains, and seeds by the application of water or other liquid (e.g., fertilizer). The coating can have a thickness of about 0.0001, 0.001, 0.01, 0.1, 0.2, 0.3, 0.4, 0.5 mm or more (or any range between about 0.0001 and 0.5 mm). The coating can represent about 1, 5, 10, 15, 20, 25% or more (or any range between about 1 and 25%) of the weight of the coated cereals, nuts, grains, or seeds. Plants, plant parts, or plant growth media can be contacted (e.g., sprayed, dusted, etc.) with formulations of the invention.

### Polymers

Seeds can additionally be coated with one or more polymers such as an aqueous polyurethane polymer dispersion. The polymers can be added to the curcumin compositions of the invention or can be added (e.g., coated, dusted, sprayed, etc.) prior to or after coating the seeds with the curcumin compositions. Coating seeds, nuts, cereals and grains with polymers can provide free flowable coated seeds, nuts, cereals, and grains.

Aqueous polyurethanes polymers can be an addition product of at least one polyisocyanate component and at least one polyol component. The polyisocyanate component generally comprises at least one diisocyanate. The isocyanate component can also comprise isocyanates of higher functionality, for example triisocyanates or oligomeric isocyanates having on average more than two and preferably three or more isocyanate groups. The polyol component can comprise at least one diol. The polyol component can further comprise higher-functionality polyols or oligomeric polyols having on average more than two OH groups, such as three, four or more OH groups. The polyurethane can also comprise urea groups based on the reaction of amines with isocyanates.

Aqueous-based polyurethane polymer dispersions and methods for making them are described in, for example, U.S. Pat. Nos. 4,528,323; 4,871,798; 5,124,400; 5,270,433; 5,432,228; 5,494,960; 5,576,382; 5,616,400; 5,703,158; 5,981,650; and 6,433,073.

Aqueous polyurethane polymer dispersions are water based dispersions that have good performance properties, are environmentally friendly, and contain no volatile organic compounds. Aqueous polyurethane polymer dispersions are made in at least two stages: (1) prepolymer formation and (2) dispersion formation. These stages are disclosed in, for example, WO2011/045004.

Aqueous polyurethane polymer dispersions can have film parameters comprising a tensile strength of about 25-150 MPa (megapascals) and a 100% modulus of about 3-30 MPa. The specific film parameters can be a tensile strength of about 3570 MPa and a 100% modulus of about 4-20 MPa.

An aqueous polyurethane polymer dispersion used can be an anionic aliphatic polyester-polyurethane dispersion, for example, Impranil® DLH or XP 2611, or aliphatic isocyanates and polyols.

An aqueous polyurethane polymer dispersion can be used to coat seeds, nuts, cereals, and grains by optionally applying an emulsifier solution to said seeds, applying an aqueous polyurethane polymer dispersion to the seeds, removing the excess aqueous polyurethane polymer dispersion, and drying the seeds under constant motion. Other types of polymers that can be used to include polyelectrolyte complexes of an acidic polymer and basic polymer, wherein the polyelectrolyte complex is water insoluble, but adapted to swell and disintegrate when in contact with water. See, e.g., U.S. Pat. No. 4,245,432. Other polymers include, for example: polyvinyl alcohol, PAA 1 (PAA-Na+/ClO⁻); PAA 2 (PAA-Na+); PAA-HM (AA/2-ethylhexyl MAA/2-acrylamido-2-methyl propane sulfonic acid (AMPS), in mole % 75/20/5, Na-salt); PAA-HM-N (AA/benzyl MAA/2-acrylamido-2-methyl propane sulfonic acid in mole % 69/25/6, Na-salt) PAA-MA (AA/monomethyl fumarate/HEMA, in mole % 88/7/5); PAA-MA-N 1 (AA/MA/Acrylamide in mole %); PAA-MA-VAc (AA/MA/Vinylacetat in mole % 39/59/2 Na+); PAA-PS (PAA/PS 50/50, Na salt); PAA-S-MA (MA/AA/MMA/sodium salt of 2-Acrylamido-2-methylpropane sulfonic acid (AMPS-Na+)/Na in mole % 19/40/3/4/35); PAA-HP (AA/hypophoshite); PAA-starch (AA/DE 42 corn syrup mole % 88/12) PMAA-Polymer (PMAA-Na+); PMAA-bA-MMA (Emulsion copolymer of MAA/butylacrylate/MMA); PMMA-N-HM (t-Octyl Acrylamide/MMA/hydroxypropyl MAA/t-butyl amino MMA in mole % 22/35/11/31); PMA-AA-N t-Octyl Acrylamide/Isobutyl MAA/AA in mole % 21/46/34); PUR-PAA (PUR/PAA blend); PVP-PVA PVP/PVA in mole % 54/46); Starch-AA-MA (DE 10 Maltodextrin/AA-Na+/MA-Na+, Hybrid polymer, in mole % 55/10/35 38); PVP-starch (PVP/Maltodextrin in mole % 58/42 25); and PS-S 1 (sulfonated PS). (AA=acrylic aid, HEMA=2-hydroxyethylmethacrylate, MA=maleic acid, MAA=methacrylic acid, MMA=methylmethaccrylate, PS=Polystyrene, PUR=Polyurethane, PVA=Polyvinylacrylate, PVP=Polyvinylpyrrolidone).

### Fungicides

The formulations and compositions of the invention can further comprise one or more fungicides, one or more nematicides, one or more pesticides, or combinations thereof.

Fungicides are compounds or organisms that can kill or inhibit fungi or fungal spores. Examples include aliphatic nitrogen fungicides (e.g., butylamine, cymoxanil, dodicin, dodine, guazatine, iminoctadine), amide fungicides (e.g., benzovindiflupyr, carpropamid, chloraniformethan, fenoxanil, prochloraz, quinazamid, silthiofam, triforine), acylamino acid fungicides (e.g., benalaxyl, benalaxyl-M, furalaxyl, metalaxyl, metalaxyl-M, pefurazoate, valifenalate), anilide fungicides (e.g., bixafen, boscalid, carboxin, fenhexamid, metsulfovax, ofurace, oxadixyl, oxycarboxin, thifluzamide, tiadinil, vangard) benzanilide fungicides (e.g., benodanil, flutolanil, mebenil, mepronil, salicylanilide, tecloftalam), furanilide fungicides (e.g., fenfuram, furalaxyl, furcarbanil, methfuroxam), sulfonanilide fungicides (e.g., flusulfamide), benzamide fungicides (e.g., benzohydroxamic acid, fluopicolide, fluopyram, tioxymid, trichlamide, zarilamid, zoxamide), furamide fungicides (e.g., cyclafuramid, furmecyclox), phenylsulfamide fungicides (e.g., dichlofluanid, tolylfluanid), sulfonamide fungicides (e.g., amisulbrom, cyazofamid), valinamide fungicides (e.g., benthiavalicarb, iprovalicarb), antibiotic fungicides (e.g., aureofungin, blasticidin-S, cycloheximide, griseofulvin, kasugamycin, streptomycin, validamycin) strobilurin fungicides (e.g., fluoxastrobin, mandestrobin) methoxyacrylate strobilurin fungicides (e.g., azoxystrobin, bifujunzhi, coumoxystrobin, enoxastrobin, flufenoxystrobin, jiaxiangjunzhi, picoxystrobin, pyraoxystrobin), methoxycarbanilate strobilurin fungicides (e.g., pyraclostrobin, pyrametostrobin, triclopyricarb), methoxyiminoacetamide strobilurin fungicides (e.g., dimoxystrobin, fenaminstrobin, metominostrobin, orysastrobin), methoxyiminoacetate strobilurin fungicides (e.g., kresoxim-methyl, trifloxystrobin) aromatic fungicides (e.g., biphenyl, chlorodinitronaphthalenes, chloroneb, chlorothalonil, dicloran, fenjuntong, hexachlorobenzene, sodium pentachlorophenoxide, tecnazene, trichlorotrinitrobenzenes), arsenical fungicides (e.g., asomate, urbacide) aryl phenyl ketone fungicides (e.g., metrafenone, pyriofenone), benzimidazole fungicides (e.g., albendazole, benomyl, carbendazim, debacarb, rabenzazole, thiabendazole), benzimidazole precursor fungicides (e.g., furophanate, thiophanate, thiophanate-methyl), benzothiazole fungicides (e.g., bentaluron, benthiavalicarb, benthiazole, chlobenthiazone, probenazole), botanical fungicides (e.g., allicin, berberine, carvacrol, carvone, osthol, sanguinarine, santonin), bridged diphenyl fungicides (e.g., bithionol, dichlorophen, diphenylamine, hexachlorophene, parinol), carbamate fungicides (e.g., benthiavalicarb, furophanate, iodocarb, iprovalicarb, picarbutrazox, propamocarb, pyribencarb, thiophanate, thiophanate-methyl, tolprocarb), benzimidazolylcarbamate fungicides (e.g., albendazole, benomyl, carbendazim, cypendazole, debacarb, mecarbinzid), carbanilate fungicides (e.g. pyraclostrobin, pyrametostrobin, triclopyricarb), conazole fungicides, conazole fungicides (imidazoles) (e.g., climbazole, clotrimazole, imazalil, oxpoconazole, prochloraz, triflumizole), conazole fungicides (triazoles) (e.g., azaconazole, bromuconazole, cyproconazole, diclobutrazol, difenoconazole, diniconazole, diniconazole-M, fluquinconazole, flusilazole, flutriafol, furconazole, furconazole-cis, ipconazole, penconazole, propiconazole, simeconazole, triadimefon, triadimenol, triticonazole, uniconazole, uniconazole-P), copper fungicides (e.g., acypetacs-copper, copper acetate, copper carbonate basic, copper hydroxide, copper naphthenate, copper silicate, copper sulfate, copper sulfate basic, cuprous oxide, saisentong, thiodiazole-copper), cyanoacrylate fungicides (e.g., benzamacril, phenamacril), dicarboximide fungicides (e.g., famoxadone, fluoroimide), dichlorophenyl dicarboximide fungicides (e.g., chlozolinate, dichlozoline, iprodione, vinclozolin), phthalimide fungicides (e.g., captafol, thiochlorfenphim), dinitrophenol fungicides (e.g., binapacryl, dinobuton, dinocap, dinocap-4dinocap-6meptyldinocapdinocton, dinopenton, dinosulfon, dinoterbon, DNOC), dithiocarbamate fungicides (e.g., amobam, asomate, azithiram, ferbam, metam, urbacide, ziram), cyclic dithiocarbamate fungicides (e.g., dazomet, etem, milneb), polymeric dithiocarbamate fungicides (e.g., mancopper, mancozeb, maneb, metiram, zineb), dithiolane fungicides (e.g., isoprothiolane, saijunmao), fumigant fungicides (e.g., carbon disulfide, cyanogen, dithioether, methyl bromide, methyl iodide, sodium tetrathiocarbonate), hydrazide fungicides (e.g., benquinox, saijunmao), imidazole fungicides (e.g., cyazofamid, fenamidone, fenapanil, glyodin, iprodione, isovaledione, pefurazoate, triazoxide), conazole fungicides (imidazoles) (e.g., climbazole, clotrimazole, prochloraz, triflumizole), inorganic fungicides (e.g., potassium azide, potassium thiocyanate, sodium azide, sulfur, copper fungicides, inorganic mercury fungicides), mercury fungicides, inorganic mercury fungicides (e.g., mercuric chloride, mercuric oxide, mercurous chloride), organomercury fungicides (e.g., (3-ethoxypropyl)mercury bromide, ethylmercury acetate, ethylmercury bromide, N-(ethylmercury)-p-toluenesulphonanilide, hydrargaphen, methylmercury pentachlorophenoxide, 8-phenylmercurioxyquinoline, phenylmercury nitrate, phenylmercury salicylate, thiomersal, tolylmercury acetate), morpholine fungicides (e.g., aldimorph, benzamorf, carbamorph, tridemorph), organophosphorus fungicides (e.g., ampropylfos, ditalimfos, fosetyl, hexylthiofos, kejunlin, phosdiphen, triamiphos), organotin fungicides (e.g., decafentin, fentin, tributyltin oxide), oxathiin fungicides (e.g., carboxin, oxycarboxin), oxazole fungicides (e.g., chlozolinate, dichlozoline, metazoxolon, myclozolin, oxadixyl, oxathiapiprolin, pyrisoxazole, vinclozolin), polysulfide fungicides (e.g., barium polysulfide, calcium polysulfide, potassium polysulfide, sodium polysulfide), pyrazole fungicides (e.g., benzovindiflupyr, bixafen, penflufen, penthiopyrad, pyraclostrobin, sedaxane), pyridine fungicides (e.g., boscalid, buthiobate, fluopicolide, fluopyram, pyrisoxazole, triclopyricarb), pyrimidine fungicides (e.g., bupirimate, diflumetorim, ferimzone, nuarimol, triarimol), anilinopyrimidine fungicides (e.g, cyprodinil, mepanipyrim, pyrimethanil), pyrrole fungicides (e.g. dimetachlone, fenpiclonil, fludioxonil, fluoroimide), quaternary ammonium fungicides (e.g. berberine, sanguinarine), quinoline fungicides (e.g. ethoxyquin, quinoxyfen, tebufloquin), quinone fungicides (e.g. chloranil, dichlone, dithianon), quinoxaline fungicides (e.g. chinomethionat, chlorquinox, thioquinox), thiadiazole fungicides (e.g. etridiazole, saisentong, thiodiazole-copper, zinc thiazole), thiazole fungicides (e.g. ethaboxam, isotianil, metsulfovax, thifluzamide), thiazolidine fungicides (e.g. flutianil, thiadifluor), thiocarbamate fungicides (e.g. methasulfocarb, prothiocarb), thiophene fungicides (e.g. ethaboxam, isofetamid, silthiofam), triazine fungicides (e.g. anilazine), triazole fungicides (e.g. amisulbrom, bitertanol, fluotrimazole, triazbutil) conazole fungicides (triazoles) (e.g. azaconazole, bromuconazole, etaconazole, flutriafol, imibenconazole, ipconazole, simeconazole, triticonazole, uniconazole, uniconazole-P), triazolopyrimidine fungicides (e.g. ametoctradin) urea fungicides (e.g. bentaluron, pencycuron, quinazamid), zinc fungicides (e.g. acypetacs-zinc, copper zinc chromate. propineb, zinc naphthenate. ziram) and other fungicides (e.g. acibenzolar, bromothalonil, chitosan, diethyl pyrocarbonate, furfural, nitrothal-isopropyl, piperalin, spiroxamine, tricyclazole).

### Pesticides

Pesticides are active agents that kill or inhibit the growth of pests such as insects (insecticides), arachnids (arachnicides), helminthes (anthelminitic), nematodes (nematicides), molluscs (molluscicides), bacteria (bactericides), fungi (fungicides), mites (acaracides), oomycytes (oomycides) and protozoa (protozoacide). One or more pesticides can be present in the compositions and formulations of the invention. Insecticides include, for example, arsenical insecticides (e.g. calcium arsenate, copper acetoarsenite, potassium arsenite, sodium arsenite), botanical insecticides (e.g. allicin, anabasine, matrine, oxymatrine, pyrethrins, cinerins, quassia, rotenone, sanguinarine, triptolide), carbamate insecticides (e.g. bendiocarb, carbaryl) benzofuranyl methylcarbamate insecticides (e.g. benfuracarb, carbofuran, furathiocarb), dimethylcarbamate insecticides (e.g. dimetan, dimetilan, pirimicarb, pyrolan), oxime carbamate insecticides (e.g. alanycarb, aldicarb, aldoxycarb, butocarboxim, butoxycarboxim, methomyl, thiocarboxime. thiodicarb, thiofanox), phenyl methylcarbamate insecticides (e.g. allyxycarb, aminocarb, bufencarb, butacarb, dimethacarb, dioxacarb, metolcarb, mexacarbate, promacyl, promecarb, propoxur, diamide insecticides (e.g. chlorantraniliprole, cyantraniliprole, tetraniliprole), dinitrophenol insecticides (e.g. dinex, dinoprop), fluorine insecticides (e.g. barium hexafluorosilicate, cryolite, flursulamid, sodium fluoride, sulfluramid, formamidine insecticides (e.g. am itraz, chlordimeform, formetanate, formparanate, medimeform, semiamitraz), fumigant insecticides (e.g. acrylonitrile, carbon disulfide, carbon tetrachloride, carbonyl sulfide, chloroform, ethylene dibromide, methyl bromide, naphthalene, sulfuryl fluoride, tetrachloroethane), inorganic insecticides (e.g. borax, boric acid, mercurous chloride, potassium thiocyanate, sodium thiocyanate), arsenical insecticides, fluorine insecticides, insect growth regulators (e.g. chitin synthesis inhibitors, benzoylphenylurea chitin synthesis inhibitors, juvenile hormone mimics, juvenile hormones, moulting hormone agonists, moulting hormones, moulting inhibitors, precocene), macrocyclic lactone insecticides, avermectin insecticides (e.g. abamectin, doramectin, emamectin, eprinomectin, ivermectin, selamectin), milbemycin insecticides (e.g. lepimectin, milbemectin, milbemycin oxime, moxidectin), spinosyn insecticides (e.g. spinetoram, spinosad), neonicotinoid insecticides, nitroguanidine neonicotinoid insecticides (e.g. clothianidin, dinotefuran, imidacloprid, imidaclothiz, thiamethoxam), nitromethylene neonicotinoid insecticides (e.g. nitenpyram, nithiazine), pyridylmethylamine neonicotinoid insecticides (e.g. acetamiprid, imidacloprid, nitenpyram, paichongding, thiacloprid), nereistoxin analogue insecticides (e.g. bensultap, cartap, thiocyclam, thiosultap), organochlorine insecticides (e.g. camphechlor, HCH, lindanemethoxychlor, pentachlorophenol), cyclodiene insecticides (e.g. aldrin, bromocyclen, chlorbicyclen, chlordane, chlordecone, endrin, isobenzan, isodrin, kelevan, mirex), organophosphorus insecticides, organophosphate insecticides (e.g. bromfenvinfos, calvinphos, chlorfenvinphos, crotoxyphos, fospirate, heptenophos, methocrotophos, naftalofos, phosphamidon, tetrachlorvinphos), organothiophosphate insecticides (e.g. dioxabenzofos, fosmethilan, phenthoate), aliphatic organothiophosphate insecticides (e.g. acethion, acetophos, amiton, demephion, demeton, methylisothioate, oxydisulfoton, phorate, thiometon), aliphatic amide organothiophosphate insecticides (e.g. amidithion, cyanthoate, mecarbam, omethoate, prothoate, sophamide, vamidothion), oxime organothiophosphate insecticides (e.g. chlorphoxim, phoxim, phoxim-methyl), heterocyclic organothiophosphate insecticides (e.g. azamethiphos, colophonate, dioxathion, endothion, menazon, morphothion, pyridaphenthion, quinothion), benzothiopyran organothiophosphate insecticides (e.g. dithicrofos, thicrofos), benzotriazine organothiophosphate insecticides (e.g. azinphos-ethyl azinphos-methyl), isoindole organothiophosphate insecticides (e.g. dialifos, phosmet), isoxazole organothiophosphate insecticides (e.g. isoxathion, zolaprofos), pyrazolopyrimidine organothiophosphate insecticides (e.g. chlorprazophos, pyrazophos), pyridine organothiophosphate insecticides (e.g. chlorpyrifos, chlorpyrifos-methyl), pyrimidine organothiophosphate insecticides (e.g. butathiofos, diazinon, etrimfos, pirimioxyphos, primidophos, pyrimitate, tebupirimfos), quinoxaline organothiophosphate insecticides (e.g. quinalphos, quinalphos-methyl), thiadiazole organothiophosphate insecticides (e.g. athidathion, lythidathion, methidathion, prothidathion), triazole organothiophosphate insecticides (e.g. isazofos, triazophos), phenyl organothiophosphate insecticides (e.g. azothoate, carbophenothion, chlorthiophos, dicapthon, dichlofenthion, etaphos, famphur, fenthion, jodfenphos, phenkapton, sulprofos, temephos, trifenofos, xiaochongliulin), phosphonate insecticides (e.g. butonate, trichlorfon), phosphonothioate insecticides (e.g. mecarphon), phenyl ethylphosphonothioate insecticides (e.g. fonofos, trichloronat), phenyl phenylphosphonothioate insecticides (e.g. cyanofenphos, leptophos), phosphoramidate insecticides (e.g. crufomate, mephosfolan, pirimetaphos), phosphoramidothioate insecticides (e.g. acephate, chloramine phosphorus, isofenphos, metham idophos), phosphorodiamide insecticides (e.g. dimefox, mazidox, schradan), oxadiazine insecticides (e.g. indoxacarb), oxadiazolone insecticides (e.g. metoxadiazone), phthalimide insecticides (e.g. dialifos, phosmet, tetramethrin), physical insecticides (e.g. maltodextrin), desiccant insecticides (e.g. boric acid, diatomaceous earth, silica gel), pyrazole insecticides (e.g. chlorantraniliprole, isolan, tolfenpyrad), phenylpyrazole insecticides (e.g. acetoprole, ethiprole, pyrolan, vaniliprole), pyrethroid insecticides, pyrethroid ester insecticides (e.g. acrinathrin, brofenvalerate, cyhalothrin, dimethrin, meperfluthrin, proparthrin, tralocythrin), pyrethroid ether insecticides (e.g. etofenprox, protrifenbute, silafluofen), pyrethroid oxime insecticides (e.g. sulfoxime, thiofluoximate), pyrimidinamine insecticides (e.g. flufenerim, pyrimidifen), pyrrole insecticides (e.g. chlorfenapyr), quaternary ammonium insecticides (e.g. sanguinarine), sulfoximine insecticides (e.g. sulfoxaflor), tetramic acid insecticides (e.g. spirotetramat), tetronic acid insecticides (e.g. spiromesifen), thiazole insecticides (e.g. clothianidin, imidaclothiz, thiamethoxam, thiapronil), thiazolidine insecticides (e.g. tazimcarb, thiacloprid), thiourea insecticides (e.g. diafenthiuron), urea insecticides (e.g. flucofuron, sulcofuron), zwitterionic insecticides (e.g. triflumezopyrim), unclassified insecticides (e.g. afidopyropen, afoxolaner, allosamidin, closantel, copper naphthenate, crotamiton, isoprothiolane, pyridaben, thuringiensin, triarathene, triazamate).

### Nematicides

Nematicides kill or inhibit nematodes. Two broad categories of nematicides are currently registered and available for use (Whitehead, 1998, Plant Nematode Control. CAB International, Walling Ford, UK). The classification system is based upon the way these chemicals move in soil. Fumigant nematicides, including methyl bromide, methyl iodide, chloropicrin, ethylene dibromide, 1,3-dichloropene, dimethyl dibromide and metam sodium and potassium, dazomet, methyl isothiocyanate, are formulated as liquids that rapidly vaporize and move through open air spaces in soil as a gas. Non-fumigant nematicides, including 2-methyl-2-(methylthio)propionaldehyde O-methylcarbamoyloxime (Temik®, Bayer CropScience), 2,3-Dihydro-2,2-dimethyl-7-benzofuranyl methylcarbamate (Furadan), 2-methyl-2 (methylsulfonyl)propanal-O-(methylaminocarbonyl oximel (Standak™, BASF), O,O-diethyl O-[p-(methylsulfinyl)phenyl] ester (Dasanit), Ethyl 4-methylthio-m-tolyl isopropylphosphoramidate (Nemacur, Makhteshim Agan Group), O-ethyl S,S-dipropyl phosphorodithioate (MOCAP®, Bayer CropScience), Methyl N′N′-dimethyl-N-[(methylcarbamoyl)oxy]-1-thiooxamimidate (Vydate®, Dupont), and S-[[(1,1-dimethylethyl) thio] methyl]0,0-diethyl phosphorodithioate (Counter), thionazin (Nemafos), Isazofos (Miral), Ebufos (Rugby), Cleothocarb (Lance) are organophosphates and/or carbamates. The non-fumigant nematicides are often further classified as contact or systemic nematicides, depending on whether they kill nematodes in soil by contact, or are taken up by the plant first and affect nematodes when they feed from cellular fluids within the plant.

### Pests

The compositions of the invention can be used to prevent infection by or reduce the numbers of plant pests on seeds, nuts, cereals, and grains, in or on soil or other plant growth medium, and to prevent infection or reduce the numbers of plant pests on plants or plant material such as roots, fruits and seeds. In another embodiment of the invention, the compositions of the invention can reduce the damaging effect of plant pests on the plant by, for example, killing, injuring or slowing the activity of the pest. Plant pests include, for example, insects, arachnids, helminths, nematodes, mollusks, bacteria, fungi, mites, oomycetes and protozoa. Compositions of the invention can be used to control, kill, injure, paralyze, or reduce the activity of one or more of any of these pests in their egg, larvae, adult, juvenile, or desiccated forms.

Nematodes that damage plants include, for example, Meloidogyne spp. (root-knot), Heterodera spp., Globodera spp., Pratylenchus spp., Helicotylenchus spp., Radopholus similis, Ditylenchus dipsaci, Rotylenchulus reniformis, Xiphinema spp., Aphelenchoides spp. and Belonolaimus longicaudatus.

The root-knot group Meloidogyne spp of nematodes are particularly important to control (Sasser, Plant Disease, 104:36 (1980)). Their worldwide distribution, extensive host ranges and involvement with fungi, bacteria, and viruses in disease complexes rank them among the top major plant pathogens affecting the global food supply. Collectively, the various species of root-knot attack nearly every crop grown. The most common species are M. incognita, M. arenaria, M. hapla and M. javanica (Sasser, Phytopathology, 42:216 (1952); Sasser, Bull. Md. Agric. Exp. Stn. A-77 (Techn) p. 31 (1954)). Not only are yields greatly affected, but production quality is also reduced. Infections by root-knot nematode cause decline in the host, and under some conditions, may kill the plant (Sasser, 1980).

Among the crops with the greatest estimated losses due to nematode parasitism are corn, cotton, cucurbits, leguminous vegetables, peanut, solanaceous vegetables, soybean, sugarcane, and tobacco.

Insects cause two types of damage to plants. The first type of damage is direct injury done to the plant by the insect, which eats leaves or burrows into plant tissues. There are a multitude of insect species of this type, both larvae and adults, among orthopterans, homopterans, heteropterans, coleopterans, lepidopterans, and dipterans. The second type of damage is indirect damage where the insect itself does little or no harm but transmits a bacterial, viral, or fungal infection to a plant. Insects that cause these two types of damage to plants include, for example, Coleoptera (beetles, weevils), Cerambycidae (long-horned beetles), Chrysomelidae (leaf beetles), Coccinellidae (lady beetles), Curculionidae (snout beetles, weevils, billbugs), Elateridae (click beetles), Meloidae (blister beetles), Scarabaeidae (scarab beetles), Tenebrionidae (darkling beetles), Diptera (flies), Anthomyiidae (root maggot flies), Cecidomyiidae (midges), Hemiptera suborder heteroptera (true bugs), Lygaeidae (seed bugs, chinch bugs), Miridae (plant bugs, lygus bugs), Pentatomidae (stink bugs), Hemiptera suborder homoptera (aphids, whiteflies, leafhoppers, scales), Aleyrodidae (whiteflies), Aphididae (aphids), Cercopidae (spittlebugs), Cicadellidae (leafhoppers), Membracidae (treehoppers), Lepidoptera (moths, butterflies), Noctuidae (cutworm moths), Pyralidae (snout and grass moths), Sphingidae (sphinx moths), Orthoptera (grasshoppers and crickets), Acrididae (short-horned grasshoppers), Gryllidae (crickets), Gryllotalpidae (mole crickets), Thysanoptera (thrips), Thripidae (common thrips), Acarina (mites), Tetranychidae (spider mites).

Arachnids such as earth mites (Penthaleidae), thread-footed mites (Tarsonemidae) and gall and rust mites (Eriophyoidea) can also cause damage to plants.

Mollusks, including those in the gastropod class and those in the subclass pulmonata, can cause damage to plants. Mollusks also include, for example, snails and slugs, such as Ampullariidae spp.; Anion spp. (A. ater, A. circumscriptus, A. hortensis, A. rufus); Bradybaenidae spp. (Bradybaena fruticum); Cepaea spp. (C. hortensis, C. nemoralis); Ochlodina; Deroceras spp. (D. agrestis, D. empiricorum, D. laeve, D. reticulatum); Discus spp. (D. rotundatus); Euomphalia spp.; Galba spp. (G. trunculata); Helicelia spp. (H. itala, H. obvia); Helicidae spp. (Helicigona arbustorum); Helicodiscus spp.; Helix spp. (H. aperta); Limax spp. (L. cinereoniger, L. flavus, L. marginatus, L. maximus, L. tenellus); Lymnaea spp.; Milax spp. (M. gagates, M. marginatus, M. sowerbyi); Opeas spp.; Pomacea spp. (P. canaticulata); Vallonia spp. and Zanitoides.

Fungi that negatively affect plants include, for example, Ascomycetes such as Fusarium, Thielaviopsis, Verticillium, Magnaporthe grisea, and Sclerotinia sclerotiorum, Basidiomycetes such as Ustilago, Rhizoctonia, Phakospora pachyrhizi, Puccinia, and Armillaria, Oomycetes such as Phytophthora, Pythium, and Phytophthora, Phytomyxea such as Plasmodiophora and Spongospora.

Bacteria can also be controlled by the compositions and methods of the invention. Bacteria include, for example, Agrobacterium, Erwinia, Burkholderia, Proteobacteria such as Xanthomonas and Pseudomonas, Phytoplasma, Spiroplasma.

Any type of plant, plant tissue, seed, nut, cereal, grain, or plant growth media, or soil can be treated with the compositions of the invention. Plants include algae, bryophytes, tracheophytes, and angiosperms. Angiosperms include, for example, flowering plants, cycads, Ginkgo biloba, and conifers. Plants include seedlings, mature plants, trees and turf. Plant tissues can include, for example, roots, leaves, stems, flowers, seeds, and fruits.

### Liposomes

One or more components of the formulations and compositions of the invention can be present in a liposome that is applied to the seeds, nuts, grains, cereals, plant growth medium, plants, plant parts, or reproductive plant material. For example, a solvent, curcumin, one or more fungicides, one or more nematicides, one or more pesticides, or combinations thereof can be present in a one or more liposomes. The one or more liposomes can optionally also comprise carboxymethyl cellulose. The solvent can be a polar aprotic solvent, e.g., dimethyl sulfoxide (DMSO). The solvent can be a polar protic solvent, e.g., water. Optionally, one or more of carboxymethyl cellulose, dimethyl sulfoxide, curcumin, one or more fungicides, one or more nematicides, one or more pesticides, or combinations thereof are present in one or more liposomes and one or more of carboxymethyl cellulose, dimethyl sulfoxide, curcumin, one or more fungicides, one or more nematicides, one or more pesticides, or combinations thereof are not present in a liposome, wherein the liposome component and non-liposome components are both applied or coated on the seeds, nuts, grains, and cereals.

Formulations to be applied to the seeds, nuts, grains, and cereals can include, for example, (1) solvent, curcumin, one or more fungicides, one or more nematicides, one or more pesticides, or combinations thereof present in a single multilayer liposome, wherein the multilayered liposome is applied seeds, nuts, grains, cereals, plant growth medium, plants, plant parts, reproductive plant materials or combinations thereof; (2) solvent, curcumin or combinations thereof in one liposome and one or more fungicides, one or more nematicides, one or more pesticides, or combinations thereof, wherein the liposome and the one or more fungicides, one or more nematicides, one or more pesticides, or combinations thereof are applied to seeds, nuts, grains, cereals, plant growth medium, plants, plant parts, reproductive plant materials or combinations thereof; (3) solvent, curcumin or combinations thereof in one liposome and one or more fungicides, one or more nematicides, one or more pesticides, or combinations thereof, present in one or more second liposomes, wherein the two or more types of liposomes, are applied to seeds, nuts, grains, cereals, plant growth medium, plants, plant parts, reproductive plant materials or combinations thereof; (4) solvent, curcumin or combinations thereof and one or more fungicides, one or more nematicides, one or more pesticides, or combinations thereof present in one or more liposomes, wherein the carboxymethyl cellulose, dimethyl sulfoxide, curcumin or combinations thereof and one or more liposomes are applied to seeds, nuts, grains, cereals, plant growth medium, plants, plant parts, reproductive plant materials or combinations thereof; (5) curcumin and solvent (not within a liposome), and one or more fungicides, pesticides, or nematicides in one or more liposomes are applied to seeds, nuts, grains, cereals, plant growth medium, plants, plant parts, reproductive plant materials or combinations thereof; (6) curcumin and solvent (not within a liposome), and one or more fungicides, pesticides, or nematicides (not within a liposome) are applied to seeds, nuts, grains, cereals, plant growth medium, plants, plant parts, reproductive plant materials or combinations thereof (this can be applied as a liquid formulation or any other type of formulation). For each of (1)-(6) above, carboxymethyl cellulose may optionally be present with the solvent and curcumin. The solvent can be a polar aprotic solvent, e.g., dimethyl sulfoxide (DMSO). The solvent can be a polar protic solvent, e.g., water. For each of formulations (1) through (6) above, one or more polymers as discussed in the “Polymers” section can be coated on the seeds, nuts, grains, cereals, plant growth medium, plants, plant parts, reproductive plant materials or combinations thereof either prior to application of formulations (1) through (6) above or after application of formulations (1) through (6) above. One or more polymers also can be mixed in with one or more of the components of (1) through (6) above.

Liposomes of the invention include, for example, small unilamellar vesicles (SUVs) formed by a single lipid bilayer, large unilamellar vesicles (LUVs), which are vesicles with relatively large particles formed by a single lipid bilayer, and multi-lamellar vesicles (MLVs), which are formed by multiple membrane layers. Liposomes can be of any particle size, for example the mean particle diameter can be about 10 to about 2000 nm. In one embodiment of the invention, the mean particle diameter is about 10, 20, 25, 30, 40, 50, 100, 200, 300, 400, 500, 600, 700, 800, 900, 1,000, 1,250, 1,500, 1,750, 2,000 nm (or any range between about 10 and about 2,000 nm) or more. In one embodiment of the invention, the mean particle diameter is about 2,000, 1,750, 1,500, 1,250, 1,000, 900, 800, 700, 600, 500, 400, 300, 200, 100, 50, 40, 30, 25, 20, 10 nm (or any range between about 2,000 and 10 nm) or less. The mean particle diameter may be about 20 to about 1,000 nm, about 100 to about 1,500 nm, about 100 to about 1,000 nm, about 100 to about 700 nm, about 200 to about 2,000 nm, about 1,000 to about 2,000 nm, or about 750 to about 1,500 nm. Particle diameter refers to the diameter of a particle measured by dynamic light scattering.

Liposome manufacture comprises, for example, drying down of the lipids from organic solvents, dispersion of the lipids in aqueous media, purification of the resultant liposomes, and analysis of the final product. Some methods of liposome manufacture include, for example, extrusion methods, the Mozafari method, the polyol dilution method, the bubble method, and the heating method. Pesticides, fungicides, nematicides, curcumin, and combinations thereof can be entrapped in lipid vesicles by any method including, for example, reverse-phase evaporation technique, ether injection/vaporization technique and the freeze-thaw method.

Examples of lipids that can be used to make liposomes of the invention include soybean lecithin, hydrogenated soybean lecithin, egg yolk lecithin, phosphatidylcholines, phosphatidylserines phosphatidylethanolamines, phosphatidyl inositols, sphingomyelins, phosphatidic acids, long-chain alkyl phosphates, gangliosides, glycolipids, phosphatidyl glycerols, and cholesterols. Phosphatidylcholines include, for example, dimyristoylphosphatidylcholine, dipalmitoylphosphatidylcholine, and distearoyl phosphatidylcholine. Phosphatidylserines include, for example, dipalmitoyl phosphatidylserine, dipalmitoyl phosphatidylserine (sodium salt), and phosphatidylserine (sodium salt) derived from bovine brain. Phosphatidylethanolamines include, for example, dimyristoyl phosphatidylethanolamine, dipalmitoyl phosphatidylethanolamine, and distearoyl phosphatidylethanolamine. Phosphatidyl inositols include, for example, phosphatidylinositol (sodium salt) derived from wheat. Sphingomyelins include for example, sphingomyelin derived from bovine brain. Phosphatidic acids and long-chain alkyl phosphates include, for example, dimyristoyl phosphatidic acid, dipalmitoyl phosphatidic acid, distearoyl phosphatidic acid, and dicetyl phosphate. Gangliosides include, for example, ganglioside GM1, ganglioside GD1a, and ganglioside GT1b. Glycolipids include, for example, galactosyl ceramide, glucosyl ceramide, lactosyl ceramide, phosphatide, and globoside. Phosphatidyl glycerols include, for example, dimyristoyl phosphatidylglycerol, dipalmitoyl phosphatidylglycerol, and distearoyl phosphatidylglycerol.

A liposome composition of the invention can comprise about 0.001, 0.01, 0.1, 1.0, 2, 3, 4, 5, 6, 7, 8, 9, 10, 15, 20, (or any range between about 0.001 and 20) or more wt % of a pesticide, fungicide, or nematicide. A liposome composition of the invention can comprise about 20, 15, 10, 9, 8, 7, 6, 5, 4, 3, 2, 1.0, 0.1, 0.01, 0.001 (or any range between about 20 and 0.001) or less wt % of a pesticide, nematicide or fungicide. For example, a liposome composition can comprise about 0.001 to about 0.01 wt %, about 0.01 to about 0.1 wt %, about 0.1 to about 1 wt %, about 1 to about 5 wt %, or about 5 to about 10 wt %, about 10 to about 20 wt % of a pesticide, nematicide or fungicide. A liposome composition can comprise about 0.1, 0.5, 1, 2, 5, 10, 15, 20, 30, or more wt % (or any range between about 0.1 and 30 wt %) of curcumin. A liposome composition can comprise about 30, 20, 15, 10, 5, 2, 1, 0.5, 0.1 or less wt % (or any range between about 30 and 0.1 wt %) of curcumin. A liposome composition can comprise about 2, 3, 4, 5, 7, 10, 12, 15, 16, 17, 18 wt % (or any range between about 2 and 18 wt %) or more lipid phase and about 82, 83, 84, 85, 88, 90, 93, 95, 96, 97, 98 wt % (or any range between about 82 and 98 wt %) aqueous phase. The lipid phase may comprise about 2, 5, 10, 15, 20, 30, 40, 50, 60, 70, 75, or 80 wt % phospholipids, for example about 25 to about 44 wt % phospholipids.

A liposome of the invention can be loaded with about 1, 5, 10, 50, 100, 200, or 500, 1,000, 2,000 (or any range between about 1 and 2,000) or more μg/ml of nematicides, pesticides or fungicides. A liposome of the invention can be loaded with about 2,000, 1,000, 500, 200, 100, 50, 10, 5, 1 (or any range between about 2,000 and 1) or less μg/ml of nematicides, pesticides or fungicides. A liposome of the invention can be loaded with about 0.5, 1, 5, 10, 50, 75, 100, 150, 200, 300, 400 μg/mL or more of curcumin. A liposome of the invention can be loaded with one or more of curcumin, nematicides, pesticides, or fungicides.

The lipid phase may optionally comprise one or more additional agents such as thickeners, gelling agents, preservatives, stabilizers, wetting agents, pH buffering agents, emulsifiers, stearylamine, phosphatidic acid, dicetyl phosphate, sterols, cholesterol, cholesterol stearate, lanolin extracts, hydroxypropylmethycellulose, carboxy methycellulose, sodium acetate, sorbitan monolaurate, triethanolamine oleate, and sorbitol. An additional agent may be present at about 0.01, 0.1, 1, 2, 5, 7, 10, 12, or 15 wt % of the lipid phase.

A liposome composition can also include one or more additives to improve the biological performance of the composition (for example by improving wetting, retention or distribution on surfaces; resistance to rain on treated surfaces; or uptake or mobility of a liposome formulation). Such additives include surface active agents, spray additives based on oils, for example certain mineral oils or natural plant oils (such as soy bean and rape seed oil), and blends of these with other bio-enhancing adjuvants (ingredients which may aid or modify the action of a liposome formulation).

After formation and loading of liposomes with one or more pesticides, one or more nematicides, one or more fungicides, curcumin, solvent, carboxy methylcellulose or combinations thereof, the liposomes can be freeze-dried or lyophilized. See U.S. Pat. No. 4,311,712. The liposomes can be reconstituted on contact with water or another liquid. Other components can be added to the lyophilized or reconstituted liposomes, for example, water, fertilizer, pesticides, or herbicides.

The liposome formulations for application to seeds, nuts, cereals, grains, plants, plant parts, and plant growth media can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra-low volume liquids (UL), emulsifiable concentrates (EC), dispersible concentrates (DC), emulsions (both oil in water (EW) and water in oil (EO)), microemulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the liposome formulation. The formulation can be applied to seeds, nuts, cereals or grains or directly to plants, plant parts, reproductive plant parts, or plant growth medium.

Dustable powders (DP) may be prepared by mixing a liposome formulation with one or more solid diluents (for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers) and mechanically grinding the mixture to a fine powder.

Soluble powders (SP) may be prepared by mixing a liposome formulation with one or more water-soluble inorganic salts (such as sodium bicarbonate, sodium carbonate or magnesium sulfate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a liposome formulation with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a liposome formulation and one or more powdered solid diluents or carriers, or from pre-formed blank granules by absorbing a liposome formulation (or a solution thereof, in a suitable agent) in a porous granular material (such as pumice, attapulgite clays, fuller's earth, kieselguhr, diatomaceous earths or ground corn cobs) or by adsorbing a liposome formulation (or a solution thereof, in a suitable agent) on to a hard core material (such as sands, silicates, mineral carbonates, sulfates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible concentrates (DC) may be prepared by dissolving a liposome formulation in water or an organic solvent, such as a ketone, alcohol or glycol ether. These solutions may contain a surface active agent (for example to improve water dilution or prevent crystallization in a spray tank).

Emulsifiable concentrates (EC) or oil-in-water emulsions (EW) may be prepared by dissolving a liposome formulation in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO® 100, SOLVESSO® 150 and SOLVESSO® 200; SOLVESSO®), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a liposome formulation either as a liquid (if it is not a liquid at ambient temperature, it may be melted at a reasonable temperature, typically below 70° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid formulation. A liposome formulation is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a liposome formulation. SCs may be prepared by ball or bead milling the solid liposome formulation in a suitable medium, optionally with one or more dispersing agents, to produce a fine particle suspension of the compound. One or more wetting agents may be included in the composition and a suspending agent may be included to reduce the rate at which the particles settle. Alternatively, a liposome formulation may be dry milled and added to water, containing agents hereinbefore described, to produce the desired end product.

Aerosol formulations comprise a liposome formulation and a suitable propellant (for example n-butane). A liposome formulation may also be dissolved or dispersed in a suitable medium (for example water or a water miscible liquid, such as n-propanol) to provide compositions for use in non-pressurized, hand-actuated spray pumps.

A liposome formulation may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerization stage such that an aqueous dispersion of oil droplets is obtained, in which each oil droplet is encapsulated by a polymeric shell and contains a liposome formulation and, optionally, a carrier or diluent therefor. The polymeric shell may be produced by either an interfacial polycondensation reaction or by a coacervation procedure. The compositions may provide for controlled release of the liposome formulation and they may be used for seed, nut, grain or cereal treatment. A liposome formulation may also be formulated in a biodegradable polymeric matrix to provide a slow, controlled release of the compound.

A liposome formulation can be formulated for use as a nut, cereal, grain or seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating nuts, grains, cereals, and seeds may include an agent for assisting the adhesion of the composition to the nut, grain, cereal or seed (for example a mineral oil or a film-forming barrier). In a seed, nut, grain or cereal treatment a liposomal composition can be applied in an amount of about 0.0001, 0.001, 0.01, 0.1, 1.0, 5, 10, 100, 1,000, 5,000, 10,000 g per 100 kg of nuts, grains, cereals or seeds. For example from about 0.001 g to about 10 kg per 100 kg of nuts, grains, cereals or seeds.

### Methods of Preparing Compositions

Compositions of the invention can be prepared by several methods. In one embodiment of the invention, a cereal, seed, nut, grain, plant, plant part, or plant growth medium is coated or contacted by a method comprising: combining curcumin with a polar aprotic solvent to form a curcumin solution; or combining finely ground curcumin with a polar protic solvent to form a curcumin solution. The cereal, seed, nut, or grain is coated with the curcumin solution. The cereal, seed, nut or grain can further be coated with one or more fungicides, one or more nematicides, one or more pesticides, or combinations thereof. The polar aprotic solvent can be dimethyl sulfoxide (DMSO) and the polar protic solvent can be water.

In one embodiment of the invention, carboxymethyl cellulose (CMC) is combined with an aqueous solution to form an aqueous carboxymethyl cellulose solution. The carboxymethyl cellulose can be present at about 0.01 to about 0.1 g/mL of aqueous solution. The aqueous carboxymethyl cellulose solution is combined with curcumin and dimethyl sulfoxide to form a carboxymethyl cellulose, curcumin, and dimethyl sulfoxide solution. The carboxymethyl cellulose solution can be about 10 to about 50% of the carboxymethyl cellulose, curcumin, and dimethyl sulfoxide solution. A cereal, seed, nut, grain, plant, plant part, plant growth medium, or combination thereof is coated or contacted with the carboxymethyl cellulose, curcumin and dimethyl sulfoxide solution.

The cereal, seed, nut, grain, plant, plant part, or plant growth medium can be further coated with one or more fungicides, one or more nematicides, one or more pesticides, or combinations thereof. In one embodiment of the invention the one or more fungicides, one or more nematicides, one or more pesticides, or combinations thereof are present within one or more liposomes. The liposomes are coated onto the curcumin-coated cereal, seed, nut, grain, plant, plant part, plant growth medium, or combinations thereof.

In another embodiment of the invention, a cereal, seed, nut, grain, plant, plant part, and plant growth medium, or combination thereof is coated with an aqueous carboxymethyl cellulose solution to form a carboxymethyl cellulose coated cereal, seed, nut or grain, or combination thereof. The carboxymethyl cellulose can be present at about 0.01 to about 0.1 g/mL of aqueous solution. The carboxymethyl cellulose coated cereal, seed, nut, grain, plant, plant part, and plant growth medium, or combination thereof is coated with a curcumin and dimethyl sulfoxide solution. The cereal, seed, nut, grain, plant, plant part, or plant growth medium, can further be coated with one or more fungicides, one or more nematicides, one or more pesticides, or combinations thereof (including those present in liposomes) as described above.

In one embodiment of the invention curcumin is encapsulated within liposomes. The liposomes are mixed with a carboxymethyl cellulose solution. The liposomes and carboxymethyl cellulose are coated onto seeds, nuts, cereals, and grains or applied to plant growth medium, plants, plant parts, or plant reproductive parts.

In one embodiment of the invention, the one or more fungicides, one or more nematicides, one or more pesticides, or combinations thereof are not curcumin and are encapsulated in liposomes or are not present in liposomes. Wherein the one or more fungicides, one or more nematicides, one or more pesticides are present in liposomes, the liposomes can be applied to nuts, grains, seeds, cereals, plants, plant parts, and plant growth media, that are coated with carboxy methylcellulose, DMSO, curcumin or combinations thereof.

### Methods of Use of Compositions

The invention provides methods of controlling fungi, insects, nematodes, other pests, or combinations thereof. Formulations of the invention can be used as an antifungal, antipesticidal, and insecticidal seed, nut, cereal or grain coating, as a spray for the control of fungus and insects in stored seeds, nuts, grains and cereals, and as a soil or plant treatment (e.g., a spray) for the control of insects, nematodes, fungi, and other pests. The method includes coating the cereals, grains, seeds and nuts with a formulation comprising a solvent and curcumin, and optionally, CMC, one or more fungicides, one or more nematicides, one or more pesticides, one or more polymers, or combinations thereof by any of the methods of the invention. The solvent can be a polar aprotic solvent, e.g., dimethyl sulfoxide (DMSO) or a polar protic solvent, e.g., water.

The invention provides methods of cultivating a seed, nut, cereal or grain. The methods include coating the seed, nut, cereal or grain with a formulation of the invention and optionally, one or more fungicides, one or more nematicides, one or more pesticides, one or more polymers, or combinations thereof by any methods of the invention. The coated seed, nut, cereal or grain is contacted with a medium suitable for germination and water is added as needed.

The compositions of the invention can be used as an antifungal seed, nut, cereal, or grain coating for the control of, e.g., Aspergillus flavus or Fusarium in corn, soybeans, sunflower, peanuts, cotton seeds, or pistachios.

The invention provides methods of treating a plant growth medium. The methods comprise contacting plant growth medium with a formulation of the invention, and optionally, one or more fungicides, one or more nematicides, one or more pesticides, or combinations thereof. One or more of curcumin, solvent, carboxymethyl cellulose, fungicides, pesticides, nematicides or combinations thereof can be present in one or more liposomes.

The invention provides methods for treating an infection or potential infection of a plant, part of a plant, reproductive plant material (e.g., seeds, bulbs, tubers, corms, rhizomes), or seeds by fungi, insects or nematodes comprising contacting the plant, part of a plant, reproductive plant material, or seed with a formulation comprising a solvent, curcumin, and optionally, one or more of CMC, fungicides, one or more nematicides, one or more pesticides, or combinations thereof. One or more of curcumin, solvent, carboxymethyl cellulose, fungicides, pesticides, nematicides or combinations thereof can be present in one or more liposomes.

In one embodiment of the invention a formulation can reduce the numbers of fungi or the amount of fungal infection or presence of fungi in or on seeds, nuts, cereals, grains plants, parts of plants, reproductive plant materials, or growth medium, by about 5, 10, 25, 50, 75, 95% or more.

All patents, patent applications, and other scientific or technical writings referred to anywhere herein are incorporated by reference herein in their entirety. The invention illustratively described herein suitably can be practiced in the absence of any element or elements, limitation or limitations that are not specifically disclosed herein. Thus, for example, in each instance herein any of the terms “comprising”, “consisting essentially of”, and “consisting of” may be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by embodiments, optional features, modification and variation of the concepts herein disclosed may be resorted to by those skilled in the art, and that such modifications and variations are considered to be within the scope of this invention as defined by the description and the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

The following are provided for exemplification purposes only and are not intended to limit the scope of the invention described in broad terms above.

### EXAMPLES

### Example 1

Carboxy methylcellulose (CMC) (0.01 g/mL) was combined with an aqueous solution (in this case, water). The CMC solution was mixed with 1 mL of DMSO and 0.02 mg curcumin. This was sprayed on seeds and then the seeds were tumble dried. The CMC enables the release of the curcumin when the seeds, nuts, cereals, grains are exposed to liquid. The seeds were planted and watered. The water released the curcumin, which spread several millimeters around each seed.

### Example 2: Growth Experiments

Seeds were coated with 0.3 mg mL⁻¹ DMSO and 0.0368 g curcumin. Groups of coated and uncoated soybeans, corn, sunflower, and turfgrass were planted in soil and monitored for germination. The coated and uncoated soybean, corn, sunflower seeds germinated after 2 days and coated and uncoated seeds each had equal height and diameter after 3 weeks.

### Example 3: Seed Coating Field Trials

Corn seeds were washed in 3% or 1.2% sodium hypochlorite and then treated as described below. Curcumin composition Dose A was made by adding 0.5 mM curcumin in 10 mL DMSO to 1 L of water. Curcumin composition Dose B was made by adding 1.0 mM curcumin in 10 mL DMSO to 1 L of water.

Curcumin composition Dose C comprised 4 mL of 0.5 mM curcumin in DMSO, 2 mL of clothianidin corn seed insecticide (1.25 mg a.i./kernel), and 0.345 mL of fludioxonil seed fungicide (in all cases fludioxinil was present in the seed fungicide at 2.4% W/W). Curcumin composition Dose D comprised 4 mL of 1.0 mM curcumin in DMSO, 2 mL of clothianidin corn seed insecticide (1.25 mg a.i./kernel), and 0.345 mL of fludioxonil seed fungicide. The curcumin compositions were packaged into 10 mL vials. Each 10 mL vial was mixed with 1 L of water to make a slurry. The slurry was mixed with corn seeds in a mixing machine.

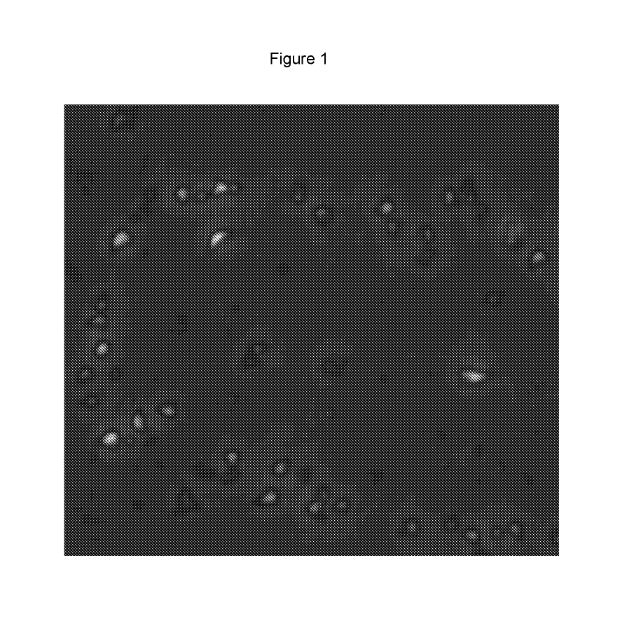

The doses were a liquid with fine particles of curcumin. Curcumin was not completely dissolved in DMSO. See FIG. 1 showing a microscopic image (20×) of the curcumin particles in the curcumin compositions. The liquid contains small curcumin particles that range in size from 400 nm to 4000 nm. These particles form the seed coating.

A “commercial treatment” was prepared with 2 mL of clothianidin corn seed insecticide treatment (1.25 mg a.i./kernel), 0.345 mL of fludioxonil seed fungicide, and 1 mL of water.

The corn seeds were dried thoroughly after treatment and were packaged and held for 2 weeks. The corn seeds were then planted in field trials.

### Example 4: Fusarium Testing

About 100-150 seeds as prepared in Example 4 were incubated for 10-14 days with a daily exposure to light. The seeds were then cultured on potato dextrose agar and/or potato sucrose agar. The seeds were then analyzed via microscopy and a percent incidence of Fusarium determined. The results are shown in Table 1.

TABLE 1

| Composition | Results Percent Incidence |
|---|---|
| Control Soil sample | Fusarium present |
| Seeds washed with 3% sodium | Fusarium present |
| hypochlorite | |
| Seeds washed with 1.2% sodium | No Fusarium present |
| hypochlorite, treated with curcumin | |
| composition Dose B | |
| Seeds washed with 1.2% sodium | 56% incidence of Fusarium |
| hypochlorite, treated with | present as compared to control |
| “commercial treatment” | soil sample |
| Seeds washed with 1.2% sodium | <10% incidence of Fusarium as |
| hypochlorite, treated with | compared to control soil sample |
| curcumin composition Dose C | |
| Seeds washed with 1.2% sodium | <10% incidence of Fusarium as |
| hypochlorite, treated with | compared to control soil sample |
| curcumin composition Dose D | |

1. (canceled)

2. The method of claim 8, wherein the curcumin solution further comprises carboxymethyl cellulose or a polymer.

3. The method of claim 8, wherein the polar aprotic solvent is dimethyl sulfoxide (DMSO) and the polar protic solvent is water.

4. (canceled)

5. (canceled)

6. The method of claim 8, wherein the curcumin is present in the solution at about 0.1 mg/L⁻¹ to about 400 mg/L⁻¹.

7. (canceled)

8. A method of coating a cereal, seed, nut, or grain comprising:
(i) (a) combining curcumin with a polar aprotic solvent to form a curcumin solution; or
(b) combining finely ground curcumin with a polar protic solvent to form a curcumin solution; and
(ii) coating the cereal, seed, nut, or grain with the curcumin solution.

9. The method of claim 8, wherein the cereal, seed, nut or grain is further coated with one or more fungicides, one or more nematicides, one or more pesticides, one or more polymers, or combinations thereof.

10. (canceled)

11. (canceled)

12. (canceled)

13. A method of cultivating a seed comprising:
(a) coating the seed with a formulation comprising (i) curcumin and a polar aprotic solvent; or (ii) finely ground curcumin and a polar protic solvent, and optionally, one or more fungicides, one or more nematicides, one or more pesticides, one or more polymers, or combinations thereof;
(b) contacting the seed with a medium suitable for germination; and
(c) adding water.

14. (canceled)

15. A method for treating an infection or potential infection of a plant, part of a plant, reproductive plant material, or seed by fungi, insects or nematodes comprising contacting the plant, part of a plant, reproductive plant material, or seed with a formulation comprising (a) curcumin and a polar aprotic solvent; or (b) finely ground curcumin and a polar protic solvent, and optionally, one or more fungicides, one or more nematicides, one or more pesticides, one or more polymers, or combinations thereof.

16. The method of claim 13, wherein the formulation further comprises carboxymethyl cellulose.

17. The method of claim 13, wherein the polar aprotic solvent is dimethyl sulfoxide (DMSO) and the polar protic solvent is water.

18. The method of claim 9, wherein the one or more fungicides, one or more nematicides, one or more pesticides, or combinations thereof are not curcumin, and wherein the one or more fungicides, one or more nematicides, one or more pesticides, one or more polymers, or combinations thereof are encapsulated in one or more liposomes.

19. The method of claim 8 further comprising coating the cereal, seed, nut, or grain with one or more liposomes containing one or more fungicides, nematicides or pesticides, one or more polymers, or combinations thereof.

20. The method of claim 13, wherein the curcumin is present in the formulation at about 0.1 mg/L⁻¹ to about 400 mg/L⁻¹.

21. The method of claim 13, wherein the seed is further coated with one or more fungicides, one or more nematicides, one or more pesticides, one or more polymers, or combinations thereof.

22. The method of claim 21, wherein the one or more fungicides, one or more nematicides, one or more pesticides, or combinations thereof are not curcumin and wherein the with one or more fungicides, one or more nematicides, one or more pesticides, one or more polymers, or combinations thereof are encapsulated in one or more liposomes.

23. The method of claim 13, further comprising coating the seed with one or more liposomes containing one or more fungicides, nematicides or pesticides, one or more polymers, or combinations thereof.

24. The method of claim 15, wherein the formulation further comprises carboxymethyl cellulose or a polymer.

25. The method of claim 15, wherein the polar aprotic solvent is dimethyl sulfoxide (DMSO) and the polar protic solvent is water.

26. The method of claim 15, wherein the curcumin is present in the formulation at about 0.1 mg/L⁻¹ to about 400 mg/L⁻¹.

27. The method of claim 15, wherein the one or more fungicides, one or more nematicides, one or more pesticides, or combinations thereof are not curcumin, and wherein one or more fungicides, one or more nematicides, one or more pesticides, one or more polymers, or combinations thereof are encapsulated in one or more liposomes.

28. The method of claim 15 further comprising contacting the plant, part of a plant, reproductive plant material, or seed with one or more liposomes containing one or more fungicides, nematicides or pesticides, one or more polymers, or combinations thereof.
